(19) United States
(12) Patent Application Publication
(10) Pub. No.: US 2019/0048962 A1
(43) Pub. Date: Feb. 14, 2019

(54) ENERGY-ABSORBING COMPONENT AND PROCESS FOR PRODUCING AN ENERGY-ABSORBING COMPONENT

(71) Applicant: BASF SE, Ludwigshafen am Rhein (DE)

(72) Inventors: Andreas WUEST, Zwingenberg (DE); Levente JUHASZ, Dudenhofen (DE); Sebastian EBLI, Schifferstadt (DE); Sebastian ALLINGER, Mannheim (DE); Daniel FERTIG, Weinheim (DE); Henrik SCHMIDT, Ludwigshafen (DE)

(73) Assignee: BASF SE, Ludwigshafen am Rhein (DE)

(21) Appl. No.: 16/077,155

(22) PCT Filed: Feb. 9, 2017
(86) PCT No.: PCT/EP2017/052825

§ 371 Date: Aug. 10, 2018

(30) Foreign Application Priority Data
Feb. 12, 2016 (EP) 16155512.3

(51) Int. Cl. F16F 7/12; B29C 70/24; B62D 21/15; B62D 29/04; B29C 65/00

(52) U.S. Cl. CPC F16F 7/124; B29C 70/24; B29C 66/7212; B62D 29/04; B62D 21/15

(57) ABSTRACT

Disclosed herein is an energy-absorbing component for absorbing energy of impacts thereon, where the energy-absorbing component can be plastically deformed by an impact and optionally can undergo at least some extent of destruction. The energy-absorbing component contains at least one core structure and at least one ancillary structure. The at least one core structure is manufactured from a first material which is a metal or is a polymer reinforced with continuous-filament fibers, and the at least one ancillary structure is manufactured from a second material which is an unreinforced polymer material or is a polymer material reinforced with short fibers or with long fibers. The at least one ancillary structure may include ribs and may be bonded to at least one core structure, so that the at least one ancillary structure supports the at least one core structure connected thereto. Processes for producing the energy-absorbing component are also disclosed.

The invention relates to an energy-absorbing component for absorbing the energy of impacts thereon, where the energy-absorbing component can be plastically deformed by an impact and optionally can undergo at least some extent of destruction. The invention further relates to a process for producing this energy-absorbing component.

Energy-absorbing components are used by way of example for bumpers in the automobile industry. They are used when, by way of example, there is a requirement for controlled dissipation of large quantities of kinetic energy from an impact in order, for example, to minimize adverse effects, for example on passengers or important and valuable adjacent structures. The energy is absorbed via deformation and controlled failure of the components, for example in the event of a collision. Because weight reduction is essential in view of the desire to reduce fuel consumption, it is desirable to manufacture the components from lighter materials, for example from plastics. Another requirement in particular for the type of energy-absorbing components used in bumpers is that the components exhibit optimized failure behavior. The aim is to absorb more energy while minimizing installation space.

WO2010/015711 A1 discloses a structure for absorbing the energy from impacts thereon. The structure is plastically deformable by an impact and can optionally, undergo at least some extent of destruction. In one embodiment the structure has reinforcing ribs, the arrangement of the ribs with respect to one another being at an angle to the axial direction in such a way that as soon as one rib fails a force acting on the structure is absorbed by another rib in axial direction. The ribs can be manufactured from a polymer material reinforced with long fibers. The structure exhibits uniform energy absorption.

The manner in which the force introduced into the energy-absorbing component acts on the component is usually unidirectional and highly dynamic. This leads to loading dominated by compressive forces. The design of the energy-absorbing components must therefore be such as to avoid the risk of buckling, i.e. mechanical instability, of the entire component. A consequence of premature buckling is that the actual physical principle used to absorb the energy (plastification, crushing, fiber breakage) cannot then operate as intended, and the energy-absorbing component does not act in the intended manner. Another important factor, alongside the risk of buckling, is that the energy-absorbing component has sufficiently high robustness in relation to the direction of the force. If, by way of example, an energy-absorbing component that is very effective when a force acts only axially is subjected to transverse forces resulting from an oblique impact, the result of this can be that the desired energy absorption cannot then be maintained, because of lateral breakaway of parts, or even of the entire energy-absorbing component.

The geometry of the known energy-absorbing components with a thermoplastic or thermoset matrix reinforced by continuous-filament fibers is very simple by virtue of the production process. Known absorbers are simple tubes or cylinders, or singly curved flat open profiles, and also multipart absorbers produced by joining simple profiles. As the shaping required for a particular force-displacement (energy) characteristic becomes more complex, the design also becomes more complex and more complicated. By way of example, continuous-filament fibers and a matrix material are first used to produce tailored prepregs before these are then further processed in a further step to give a structure. The production process greatly restricts the geometry of the energy-absorbing component, and it is therefore impossible, or possible only with very great restriction, to integrate functional elements such as screw threads and fastening systems for other adjacent structures and for the secure fastening of the energy-absorbent component itself.

The design objective for an energy-absorbing component is mostly a certain quantity of energy that is to be absorbed over a prescribed deformation distance. The requirement here is to realize a predefined force-displacement curve, for example a force-displacement curve that is as constant as possible, or else one that rises in a constant manner. An ancillary condition always required is that, in order to avoid damage to components located behind the energy-absorbing component in the direction of action of the force, it is impermissible to exceed a given maximal force. The assumed quantity of energy to be absorbed, and also the assumed maximal force, in any development here depends on the information available at the relevant point in time concerning the behavior of the remainder of the system. These requirements often change during the course of a development, or when initial trials with prototypes of the entire system are imminent. It is often difficult here, using the known design principles, to scale the energy-absorbing component that has already been developed, i.e. to adapt it to changed conditions relating to the force-displacement characteristic, with quantity of energy, or the maximal permitted force. There is therefore a requirement for an energy-absorbing component which can easily be adapted to a prescribed force-displacement characteristic.

Another object of the present invention is to provide an energy-absorbing component which also ensures controlled energy absorption when transverse forces are introduced laterally.

Another object of the present invention is to provide a process which, during the production of energy-absorbing components, permits easy adaptation of the components to provide a prescribed a force-displacement characteristic, and also permits easy adaptation of the geometry of the components.

An energy-absorbing component is proposed for absorbing the energy of impacts thereon, where the component can be, plastically deformed by an impact and optionally can undergo at least some extent of destruction. The energy-absorbing component comprises at least one core structure and at least one ancillary structure. The at least one core structure has been manufactured from a first material which is a metal or is a polymer reinforced with continuous-filament fibers, and the at least one ancillary structure has been manufactured from a second material which is an unreinforced polymer material or is a polymer material reinforced with short fibers or with long fibers. The at least one ancillary structure preferably comprises ribs and the at least one ancillary structure has been bonded to at least one core structure. It is preferable that the design of the connection and the shape of the structures are such that the at least one ancillary structure supports the at least one core structured connected thereto.

In the energy-absorbing component it is preferable that most of the energy arising during an impact is absorbed via the core structure. The at least one ancillary structure bonded to the at least one core structure here supports the core structure in a way that prevents buckling of the core structure in the event of transverse forces arising from a non-frontal impact. In particular, this prevents lateral breakaway of the core structure. The design of the core structure here is preferably such that it can absorb most of the required energy. The energy absorbed via destruction of the core structure here can be greater than in the case of the energy-absorbing components of the prior art reinforced with continuous-filament fibers, because the at least one ancillary structure bonded to the at least one core structure increases resistance to buckling. The energy-absorbing component proposed in the invention therefore also achieves an intended force-displacement characteristic during absorption of energy even when the impact is not precisely frontal, but also comprises a transverse component or lateral component.

Another advantageous embodiment provides that energy is mainly absorbed via the at least one ancillary structure, the design of the core structure in this embodiment being such that it supports the ancillary structure. This is achieved by way of example by designing the at least one core structure in such a way that this encloses the at least one ancillary structure.

The energy-absorption properties of the component, i.e. in particular a force-displacement characteristic, are preferably adjusted by varying the core structure and by varying the number of core structures used. The expression force-displacement characteristic here means the force required to deform, or to destroy, the energy-absorbing component as a function of the displacement distance, where the displacement distance is the reduction, in the direction of the force, of the dimensions of the component resulting from the progressive destruction of the component.

Variation of the core structure can in particular be achieved by varying the geometry, and/or by varying the material used.

The shape of the core structure can by way of example be that of a tube or of a cone frustum. This type of geometry can be achieved by way of example by subjecting a semifinished product, for example in sheet form, to a forming process, or the core structure can be produced directly in this shape.

In particular when a core structure is produced from a flat semifinished product, it is preferable that the core structure viewed in a planar section perpendicular to an axial direction is undulatory, zig-zag-shaped, or Ω-shaped, or is composed of linear and/or curved sections. In particular, preference is given here to shapes which comprise no undercuts, and which can therefore be produced from a flat semifinished product by draping processes.

For the purposes of the present invention, the expression axial direction means, in the case of an undeformed energy-absorbing component, the main direction of action of an impact on the component. This direction is also generally the same as the direction in which the length of the energy-absorbing component is greatest.

It is preferable that the core structure viewed in a planar section perpendicular to the axial direction comprises at least one angulation. The term angulation here means curvature with a radius of curvature that is of the order of magnitude of the smallest achievable by subjecting the material of the core structure to a forming process. These angulations provide great stability to the core structure and in the event of an impact serve as initiation points at which energy is absorbed via controlled destruction of the core structure.

If the energy-absorbing component has a hollow shape, for example that of a tube or of a hollow cone frustum, or if the energy-absorbing component has been produced from a flat semifinished sheet by a draping process, the wall thickness of the core structure is another parameter that can be varied in order to adjust the force-displacement characteristic. It is preferable here that a wall thickness of the core structure increases or decreases in an axial direction. It is thus advantageously possible that as destruction of the energy-absorbing component progresses the force required for further destruction increases.

It is preferable that the at least one core structure has been manufactured from a polymer material reinforced with continuous-filament fibers. The energy-absorbing properties of the core structure here can be influenced via appropriate selection of the polymer material reinforced with continuous-filament fibers. In particular, it is possible here to prescribe the polymer, the fibers used, the proportion of the fibers, and/or the orientation of the fibers. Alternatively, the at least one core structure has been manufactured from a metal, for example from steel or aluminum.

If the first material is a polymer material reinforced with continuous-filament fibers, the proportion of fibers is preferably in the range from 1 to 70% by volume, in particular from 10 to 60% by volume, and very particularly preferably from 20 to 50% by volume. The continuous-filament fibers of the first material can have been introduced in one or more layers into the first material. The first material here can by way of example comprise the fibers in the form of a woven fabric or in the form of parallel-oriented continuous-filament fibers. It is particularly preferably that the fibers are parallel-oriented continuous-filament fibers.

If the fibers take the form of parallel-oriented continuous-filament fibers when they are introduced into the first material, it is by way of example possible to use what are known as tapes. The continuous-filament fibers present in these have parallel orientation and have been saturated with polymer material. If the fibers are introduced in the form of a woven fabric made of continuous-filament fibers, the woven fabric comprises continuous-filament fibers which have been orientated in at least two different directions and by way of example have been woven with one another.

If fibers are introduced in a plurality of layers, the orientation of the individual layers can be varied with respect to one another in such a way that the individual fiber directions have been rotated in relation to one another. If by way of example two layers of tapes are used, the angle enclosed between the two different fiber directions can by way of example be 90°. If by way of example two woven fabrics are mutually superposed, it is preferable to rotate the two layers of woven fabric by an angle of 45° with respect to one another, thus giving an angle of 45° between each of the four fiber directions. Preference is given to a symmetrical arrangement of the layers through the thickness of the material.

It is preferable that the proportion of fibers in the first material of the at least one core structure varies in axial direction. To this end, by way of example, the proportion of fibers in the first material can increase or decrease in an axial direction. This has a result similar to a result of varying wall thickness: the energy required for the destruction of the core structures increases or decreases as displacement distance increases.

The at least one core structure in the energy-absorbing component has been bonded to the at least one ancillary structure. This bond can be a coherent, interlocking, or frictional bond. A coherent bond can be achieved by way of example by means of welding or adhesive bonding. For a coherent bond it is moreover possible to use a casting process such as injection molding, gravitational casting, or vacuum casting where at least one ancillary structure is cast onto at least one core structure, or an ancillary structure is cast around the at least one core structure. An injection-molding process is in particular suitable for this purpose. For an interlock bond it is preferable that connection elements, for example in the form of latching elements, have been formed on the at least one core structure and/or on the at least one ancillary structure. Equally, there can be connection elements, for example rivets or screw-threaded elements, provided in order to bond the at least one core structure to the at least one ancillary structure.

The at least one ancillary structure has been manufactured from the second material, and preferably has a plurality of ribs.

The second material is a polymer material which by way of example is unreinforced, i.e. is free from fibers, or is reinforced with short fibers or long fibers. Preference is given here to reinforcement with short fibers or long fibers. If the second material is fiber-reinforced, the proportion of fibers in the second material is preferably from 1 to 70% by volume, particularly preferably in the range from 10 to 60% by volume, and very particularly preferably in the range from 20 to 50% by volume.

For the purposes of the present invention, the expression long fibers means fibers typically of length in the range from 5 mm to 25 mm. For the purposes of the present invention, the expression short fibers means fibers of length below 5 mm, typical lengths of short fibers here being in the range from 0.1 mm to 1 mm.

For the purposes of the present invention, the expression continuous-filament fibers means filaments which are manufactured continuously and are shortened to a finite length during further processing, but the length of which is substantially greater the length of long fibers. The length of continuous-filament fibers can firstly be subject to restriction via the dimensions of the component, in particular via the dimensions of a core structure. The length can secondly be subject to restriction via the dimensions of the semifinished product from which a core structure is produced via a forming process. It is preferable that the length of the continuous-filament fibers is selected to be as great as possible in relation to the component or to the semifinished product, so that the length of the fibers in essence corresponds to the dimensions of a core structure or of the semifinished product.

An ancillary structure preferably has a plurality of ribs, and comprises at least one region shaped in such a way that the ancillary structure can be bonded to at least one core structure. To this end there is, by way of example, on an external side of the ancillary structure, a region shaped in a manner that permits intimate contact between a core structure and the ancillary structure. The at least one ancillary structure can moreover comprise at least one cavity shaped in a manner that allows it to receive a core structure. Alternatively, the external shape of the ancillary structure can have been prescribed via the shape of a cavity of a core structure in such a way that an ancillary structure can be received within the interior of a core structure.

The arrangement of the ribs of the ancillary structure is preferably such that the ancillary structure comprises at least one rib which runs in a first plane in axial direction and has connection with at least one rib running in a second plane in axial direction, rotated in relation to the first plane. It is preferable here that the ancillary structure comprises a plurality of ribs which are parallel to the first or second plane.

It is preferable that in addition to, or as an alternative to, ribs arranged parallel to a plane running in axial direction, the ancillary structure comprises at least one rib which runs parallel to a plane arranged perpendicularly to the axial direction. It is preferable here that ribs parallel to a plane running in axial direction intersect ribs parallel to a plane arranged perpendicularly to the axial direction. The mutually intersecting ribs here preferably form regular structures of rectangular shape. Within this rectangle formed from a plurality of ribs there can be other structures arranged for further reinforcement.

It is preferable here that a further rib divides a rectangle into two halves, where the further rib connects two diagonal corners of the rectangle to one another. It is preferable that the orientation of these ribs running diagonally is at an angle in the range from −45° to +45° to a plane arranged perpendicularly to the axial direction. This gives two triangular structures. The triangular rib structures are particularly advantageous because they provide a particularly good supportive effect.

Ribs running along the axial direction support the at least one core structure in a manner such that this cannot deviate laterally or be overturned. Ribs with orientation that is parallel or with an angle in the range from −45° to 45° to a plane arranged perpendicularly to the axial direction prevent buckling of the at least one core structure reinforced with continuous-filament fibers.

The ribs can additionally have structuring: by way of example, the ribs can have an undulatory structure or zig-zag-shaped structure.

The ancillary structure preferably moreover comprises functional regions, in particular connection regions. These connection regions serve by way of example for bonding between one or more ancillary structures, for fixing of the energy-absorbing component at its usage location, and/or for fixing other components on the energy-absorbing component.

To this end, the at least one ancillary structure can comprise, at its side facing away from an impact, a fastening plate. Arranged at the fastening plate there can in turn by way of example be fastening elements such as apertures, spring-action elements, latching elements, or screw threads which permit fastening of the energy-absorbing component at its usage location.

It is moreover possible to arrange connection regions, for example in the form of areas for screw-thread elements, domes for screw-thread elements, spring-action elements, latching elements, and fastening apertures, at other locations of an ancillary structure, thus permitting bonding of other components to the energy-absorbing component: it is by way of example conceivable, when the energy-absorbing component is used in a vehicle, to fix ancillary assemblies of the vehicle on the energy-absorbing component. This saves weight and installation space, because the energy-absorbing component also assumes a retention function.

If the first material is a polymer material reinforced with continuous-filament fibers, it is preferable that the fibers with which the first material is reinforced are selected from glass fibers, carbon fibers, aramid fibers, basalt fibers, boron fibers, metal fibers, and potassium titanate fibers.

If the second material has fiber reinforcement, the short fibers or long fibers are preferably selected from glass fibers, carbon fibers, aramid fibers, basalt fibers, boron fibers, metal fibers, and potassium titanate fibers. It is moreover possible, either in the case of the continuous-filament fibers or in the case of the short fibers or long fibers, to use combinations of the abovementioned fiber types.

If the first material is a polymer material reinforced with continuous-filament fibers, the polymer of the first material is preferably a thermoplastic polymer or a thermoset polymer. Suitable thermoset polymers are by way of example epoxy resins or polyurethane resins. However, it is particularly preferable that the polymer is a thermoplastic polymer. In this case, any of the thermoplastic polymers is in principle suitable. Examples of suitable polymers are polyamides and polypropylene, but particular preference is given to polyamides. Examples of suitable polyamides are PA 6, PA 66, PA 46, PA 6/10, PA 6T, PA 66T, PA 9T, and also PA 11 and PA 12.

The polymer of the second material is preferably a thermoset polymer processed by casting processes, or a thermoplastic polymer. However, it is particularly preferable that the polymer is a thermoplastic polymer. Any of the thermoplastic polymers is suitable here. Examples of suitable polymers are polyamides and polypropylene, but particular preference is given to polyamides. Examples of suitable polyamides are PA 6, PA 66, PA 46, PA 6/10, PA 6T, PA 66T, PA 9T, and also PA 11 and PA 12.

It is preferable that the polymers selected for the first material and for the second material are identical or that the respective polymers selected are mutually compatible. Two polymers are considered here to be compatible if a coherent bonding process such as welding, or injection of one material onto another in an injection-molding process, can be used to produce a bond with good adhesion between said materials.

It is preferable that the energy-absorbing component additionally comprises at least one insert. The insert is preferably arranged in contact with a core structure, and specifically on the side at which the impact acts on the energy-absorbing component. However, it is also possible to introduce the insert into the energy-absorbing component at other sites, for example in order to provide controlled reinforcement of the latter. It is preferable here that the insert has been fastened on the at least one ancillary structure. The insert can additionally comprise bonding means, for example a screw thread, by way of which it is possible by way of example to bond ancillary assemblies to the energy-absorbing component. The bonding means can moreover also be used to fasten the energy-absorbing component at its usage location.

If the arrangement has the insert on a core structure, it is preferable that said insert is in contact with more than one contact site on the core structure. In the event of an impact on the energy-absorbing component, the contact sites where the insert is in contact with the core structure act like a ram or a blade and thus represent initiation points for controlled destruction of the core structure, with absorption of energy. Defined and controlled energy absorption is thus ensured via controlled destruction of the core structure. It is preferable that an insert is in contact with from 1 to 10 contact sites on the core structure, thus correspondingly providing from 1 to 10 initiation points for controlled destruction. It is particularly preferable to use from 2 to 8 contact sites per core structure.

It is preferable that the insert has been manufacture from a metal or from a plastic. The shape of the insert is by way of example annular, where the annulus may have a flattened shape. By way of example, an annular insert made of metal is arranged on the continuous-filament-fiber-reinforced core structure in order to permit controlled desired delamination, i.e. splitting between layers, coupled with likewise desired breakage of fibers via axial cracks. This is achieved in that the insert described is forced or pulled axially through the core structure and thus destroys said structure with dissipation of energy. The specific design of this insert allows the respective principal modes of failure to be approached separately and appropriately, for example via a change in the number of cracks or in the cross-sectional regions involved in delamination, and thus likewise permits improvement of the above-described scalability of energy-absorption and force-displacement characteristic.

It is preferable that the energy-absorbing component comprises a housing which comprises the at least one core structure and the at least one ancillary structure. The housing can by way of example take the form of a box or of a cage and can by way of example have been manufactured from a metal or from a polymer. If the housing has been manufactured from a polymer, the selected polymer can in particular be identical with, or compatible with, the polymer of the first and/or of the second material. If the energy-absorbing component is used in a vehicle, the housing can be part of a bodywork structure of the vehicle. The housing can by way of example be a lateral sill or a roof frame of a vehicle.

The housing of the energy-absorbing component can further reinforce the stability of the at least one core structure comprised therein and of the at least one ancillary structure, and can, optionally, provide additional connection regions by way of which the energy-absorbing component can be fastened at its usage location, or by way of which ancillary assemblies can be fastened on the energy-absorbing component.

It is preferable that cavities of the energy-absorbing component have been filled with a foam. The cavities within the core structure and/or within the ancillary structure can have been filled with the foam here. If the energy-absorbing component additionally has a housing, there can be appropriate apertures or channels provided in the at least one core structure and/or in the at least one ancillary structure for the introduction of the foam, and there can be cavities likewise filled within a foam between the housing and the structures comprised therein. The foam is preferably a polyurethane foam, a polyamide foam, or an epoxy-based thermoset foam.

The foam firstly provides further support to the structures of the energy-absorbing component. Secondly, the adherent foam prevents, or at least inhibits, uncontrolled escape of sharp fragments in the event of an impact.

The energy-absorbing component must have a certain force-displacement characteristic for its specific intended purpose, and must be suitable for absorption of a prescribed quantity of energy. Another factor requiring consideration in the design of the component is that when the energy acting on the energy-absorbing component is absorbed it is necessary to avoid exceeding a prescribed maximal force, in order to avoid damage to elements arranged behind the energy-absorbing component in the direction of action of the force. Only in very rare cases moreover is it possible to consider the energy-absorbing component in isolation, because it is required to interact with other components at its prescribed usage location. Factors requiring consideration here in the design of the energy-absorbing component are in particular the exterior dimensions and the arrangement of connection regions. The division, proposed in the invention, of the energy-absorbing component into core structure and ancillary structure advantageously allows the various requirements to be allocated separately to the at least one core structure and to the at least one ancillary structure: by way of example, the intended connection regions and the exterior dimension of the energy-absorbing component can be prescribed by way of the at least one ancillary structure, while appropriate adaptation for the quantity of energy to be absorbed, and also for the force-displacement characteristic, is achieved by varying exclusively the at least one core structure in respect of the nature thereof and/or of the number thereof. This permits scaling of the performance of an energy-absorbing component in accordance with requirements, without a change to exterior design or the arrangement of the connection regions of the energy-absorbing component. If the energy-absorbing component of the invention is by way of example to be used with identical exterior geometric design in vehicles of different mass which require introduction of a different quantity of energy, the force-displacement characteristic can be scaled via simple change of the at least one core structure. By way of example, it is possible to vary wall thickness, fiber/polymer-material combination, layer structure in longitudinal and thickness direction, reinforcement architecture, and fiber content, without changing the exterior design of the component. The expression reinforcement architecture here means the selection of the arrangement of the fibers within the core structure.

If the energy-absorbing component is by way of example intended for use in a motor vehicle, it is possible to use shapes and dimensions, and also fastening points, that are standardized across the various types of vehicle, while the force-displacement characteristic and the quantity of energy that can be absorbed is respectively adjusted via different selection of the at least one core structure. Equally, it is thus possible to change the design of the energy-absorbing component in the design of the vehicle without any resultant effects on other components of the vehicle, for example other components fastened on the energy-absorbing component.

Another advantage is that the energy-absorbing component proposed can combine the good energy-absorption properties of structures reinforced with continuous-filament fibers with the advantages of complex geometry of non-fiber-reinforced structures or structures reinforced only with short fibers or long fibers. The structures reinforced with continuous-filament fibers can absorb energy by way of various destruction mechanisms, in particular by way of the energy required to break the continuous-filament fibers, and also by way of the energy required for delamination of the various layers of the continuous-filament-fiber-reinforced material. The proposed ancillary structure has a particularly advantageous effect here because this prevents buckling or lateral breakaway of the structures reinforced with continuous-filament fibers in the event of impacts involving forces in a transverse direction. The controlled absorption of the energy via defined and controlled destruction of the energy-absorbing component can advantageously be further improved by introducing inserts. These can be arranged in front of the core structures in the direction of impact, providing defined initiation points for destruction of the core structure. The failure mechanism of the energy-absorbing component is therefore prescribed in a controlled manner via the introduction of the ancillary structures and optionally of the inserts in a way that permits control of the failure behavior of the component not only in the event of frontal impacts but also in the event of a force acting with transverse components. The energy-absorbing component of the invention therefore achieves the prescribed energy absorption even when conditions are not ideal. Failure behavior in the event of an impact here is prescribed in particular via selection of the number of core structures, selection of the material of the core structures, selection of the fiber material of the core structures, selection of the proportion of fiber in the core structure, selection of the wall thickness of the core structure, and/or selection of the number of contact sites of an insert arranged on the core structure.

It is preferable that the energy-absorbing component comprises at least two ancillary structures joined together. The ancillary structures here can by way of example be bonded by connection elements such as screw-threaded elements or rivets, or by welding or adhesive bonding. The bonding of a plurality of ancillary structures also permits easy manufacture of structures with undercuts in a casting process.

A further aspect of the invention is provision of a process for the production of this energy-absorbing component. The features disclosed in the context of the description of the energy-absorbing component are also regarded as disclosed for the process here, and conversely the features described in the context of the process are also regarded as disclosed in connection with the energy-absorbing component.

In the proposed process for the production of energy-absorbing component with at least one core structure and at least one ancillary structure, either at least one core structure or at least one semifinished sheet is placed in a mold. The mold comprises at least two mold profiles movable in opposite direction, where protruding regions and depressed regions of the mold profiles comprise a negative image of an ancillary structure. The core structure and, respectively, the semifinished sheet have been manufactured from a first material selected from a metal or a polymer material reinforced with continuous-filament fibers.

In a subsequent step of the process, the mold is closed, where on closure of the mold any semifinished product inserted is subjected to a forming process to give a core structure. A second material is then injected into the closed mold, and the at least one ancillary structure is formed here. The second material is a polymer material which is free from fibers or which comprises, for reinforcement, short fibers or long fibers. After the production of the ancillary structure, the mold is opened and the resultant component is removed.

If, as in the second variant, a semifinished sheet is inserted into the mold, this is preferably a thermoplastic laminate reinforced with continuous-filament fibers. This is by way of example an organopanel which comprises one or more layers of a woven fabric made of continuous-filament fibers, or is a laid scrim composed of unidirectional continuous-filament-fiber-reinforced and polymer-matrix-preimpregnated tapes.

For the purposes of the present invention it is likewise possible that the semifinished products are, by way of an isolated process, submitted in advance to a forming process. By way of example, the semifinished products or preforms used can be produced in advance at another location, and placing of the resultant core structures into the injection mold can be delayed until the final production process takes place.

The semifinished product placed into the mold is preferably heated before placing, so that the mold can subject it to a forming process to give the final shape.

It is preferably that at least one insert is additionally placed in the mold before closure of the mold. The insert here can by way of example be arranged in such a way that the arrangement has same in front of a core structure when viewed in the direction of impact onto the energy-absorbing component. The insert has preferably been manufactured from a metal or from a polymer, particular preference being given here to metals.

It is also possible, in addition or alternatively, to arrange at least one insert after the casting of the ancillary structure. To this end it is preferable to provide connection structures such as spring-loaded elements or latching elements on the ancillary structure, and/or the insert can be connected to the ancillary structure via screw-thread elements, riveting or adhesive bonding.

After opening of the mold it is possible to remove the shaped component and to insert same into a housing. The component here can be bonded securely to the housing by way of example by a bonding process using welding, adhesive bonding, or riveting. The housing can be open at the areas situated in axial direction in the energy-absorbing component.

After production of the ancillary structure, cavities present in the energy-absorbing component can be filled with a foam. Cavities located between parts of the core structure and/or of the ancillary structure and the optionally present housing are also optionally filled here. It is preferable that apertures and/or channels are arranged in the core structure and/or in the at least one ancillary structure for the introduction of the foam. The filling of the cavities with the foam can take place after removal of the component from the mold. Alternatively, parts of the mold can be replaced before removal from the mold, in such a way that new cavities form which can then be filled by the foam.

It is preferable that a plurality of components produced with the aid of the proposed process are bonded to one another by a jointing process such as adhesive bonding, welding, riveting, or use of screw threads, to form a larger energy-absorbing component. However, each component comprising at least one core structure and at least one ancillary structure itself forms a functional energy-absorbing component.

The proposed production process permits simultaneous manufacture of a core structure reinforced with continuous-filament fibers, and also of the at least one ancillary structure. It is advantageously possible here that the at least one core structure and the at least one ancillary structure can be simultaneously bonded coherently to one another. To this end, the selected polymers of the first material of the at least one core structure and of the second material of the at least one ancillary structure are advantageously identical or compatible, so that the at least one ancillary structure can be molded onto the at least one core structure.

In the proposed process it is advantageously possible to adjust the force-displacement characteristic, and also the quantity of energy that can be absorbed, appropriately without changes to the mold. This is achieved simply via appropriate adjustment of the core structure placed in the mold/the number of core structures used. If a semifinished product is used, it is equally possible to make appropriate adjustment of the number of semifinished products put in place, and also of the material of the semifinished products. There is advantageously no requirement here for any complicated change of mold or production of a new mold.

The separation of the energy-absorbing component into core structure and ancillary structure moreover facilitates integration of additional functionality into the component. If the at least one ancillary structure is produced by way of example by the injection-molding process, it is possible to make use of all of the possibilities offered by injection-molding technology. Molding-on of flanges, and integration of retention systems, holes, screw-threaded inserts, and spring-loaded connectors is possible, as also is the further functional integration of inserts, for example made of metal. The invention described can thus provide access to a component which firstly has the energy-absorption property required in the event of an impact and secondly assumes other primary or secondary structural functions. By way of example, the energy-absorbing component described in the invention can be part of a retention system for a highly integrated holder for a vehicle cooling system, or part of a stiffening insert in the bodywork of a vehicle.

In one particularly preferred embodiment of the invention, a separate insert made of metal is concomitantly integrated into the energy-absorbing component during the injection-molding process or thereafter. A first function of this integrated insert can consist in connecting adjacent parts to the energy-absorbing component. These can be by way of example in the frontal region of a vehicle retention system for lamps, cooling systems, or other ancillary assemblies. By virtue of the insert, the fastening of the energy-absorbing component can preferably also provide specific support and reinforcement for the purposes of force transmission.

The proposed energy-absorbing component is in particular suitable for use in motor vehicles. Examples of possible installation sites in a motor vehicle are under the engine hood, in the region of the lateral sills, in the door module, or in the interior under cladding elements. Another possibility alongside use in a motor vehicle is use of the energy-absorbing component in packaging technology for the protection of goods requiring packaging.

An example of another application is stationary use of the energy-absorbing component in road traffic applications, for example in signposts, traffic barriers, lane separators, or temporary structures at construction sites, or on buildings requiring protection. In the event of a vehicle impact here, the kinetic energy is dissipated in a controlled manner in such a way that the vehicle occupants are exposed only to slight adverse effects.

Embodiments of the invention are depicted in the figures and are explained in more detail in the description below.

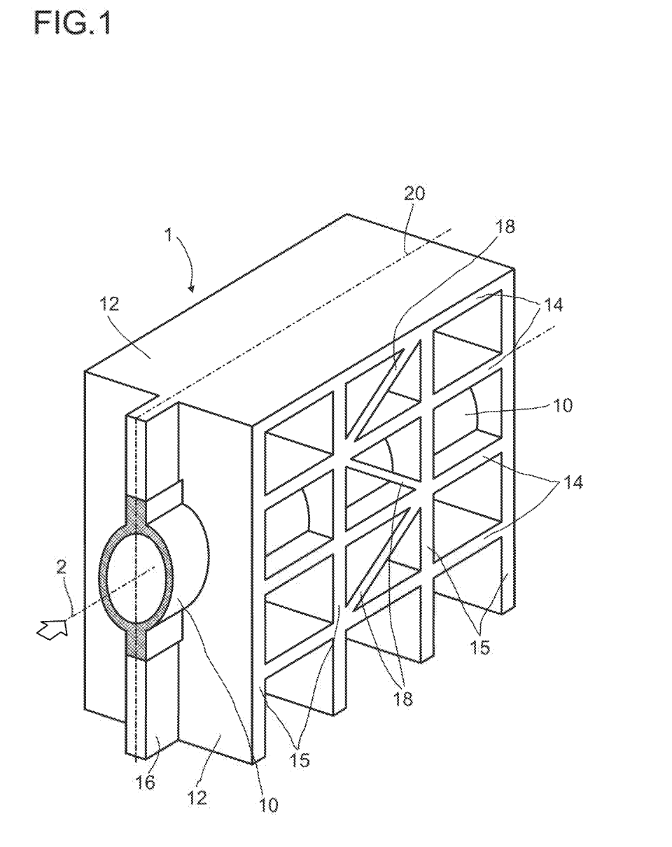

FIG. 1 is a perspective view of an energy-absorbing component of the invention,

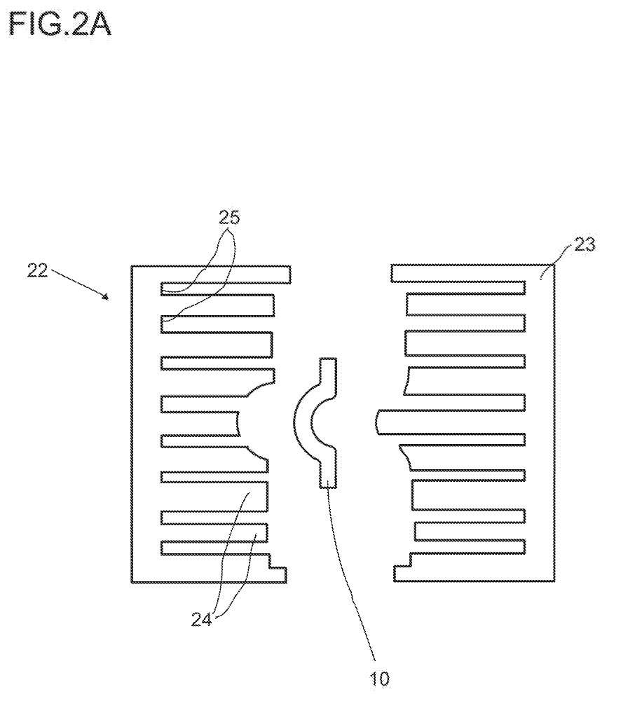

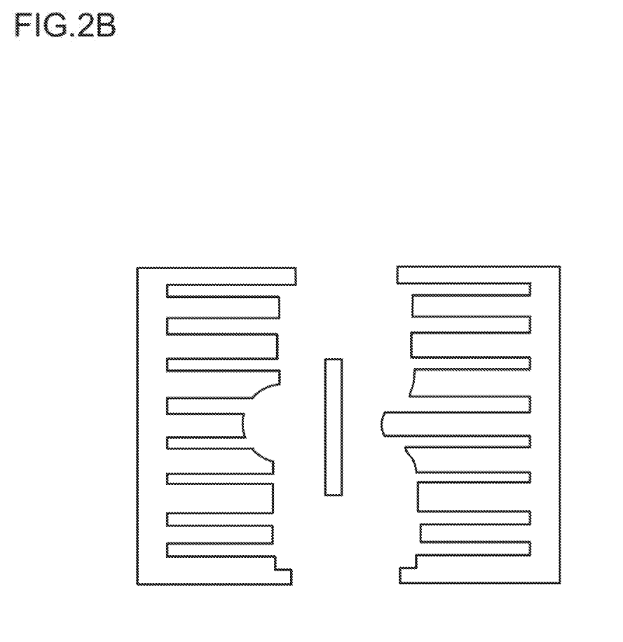

FIG. 2a shows the production of an energy-absorbing component via placing of a core structure,

FIG. 2b shows the production of an energy-absorbing component via placing of a semifinished product,

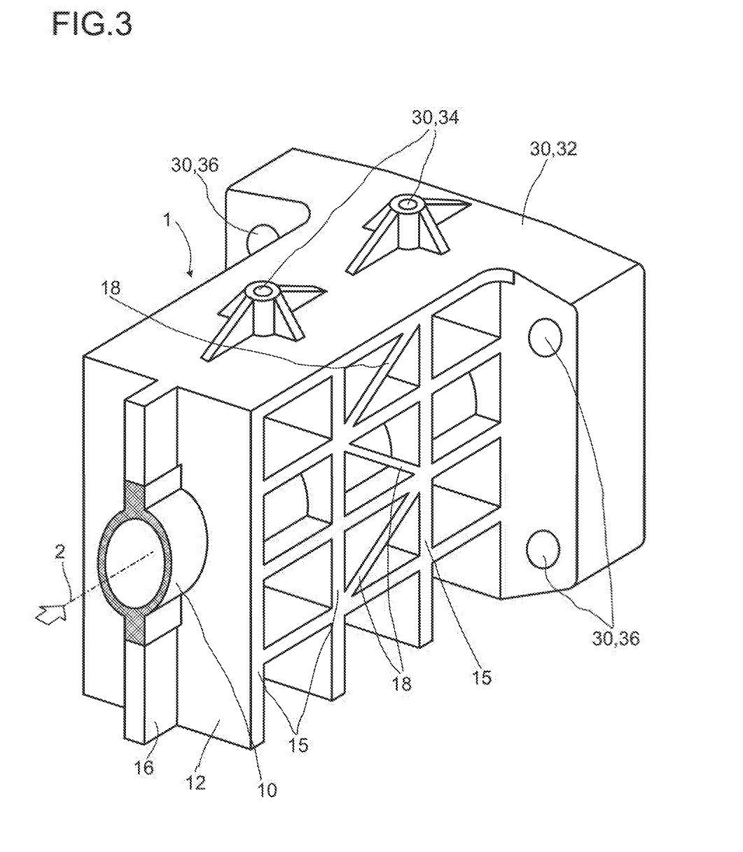

FIG. 3 is a perspective view of an energy-absorbing component with connection regions,

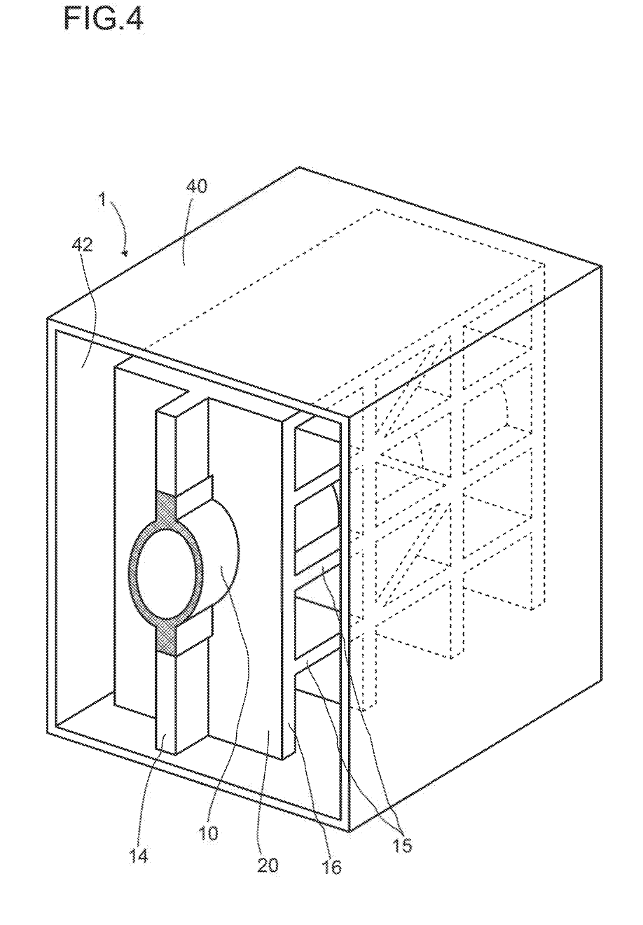

FIG. 4 is a perspective view of an energy-absorbing component with a housing,

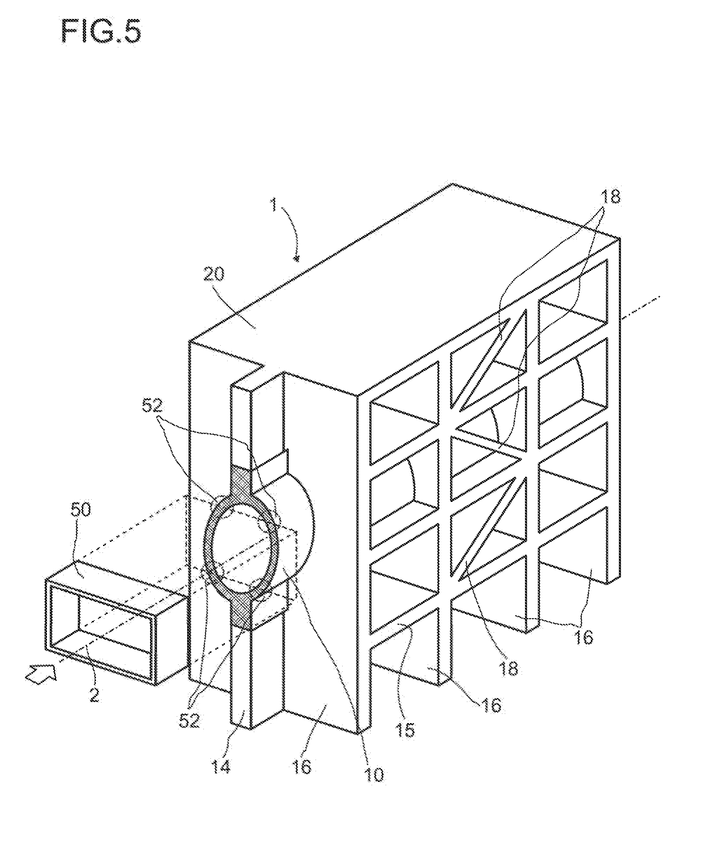

FIG. 5 shows an arrangement of an insert in an energy-absorbing component,

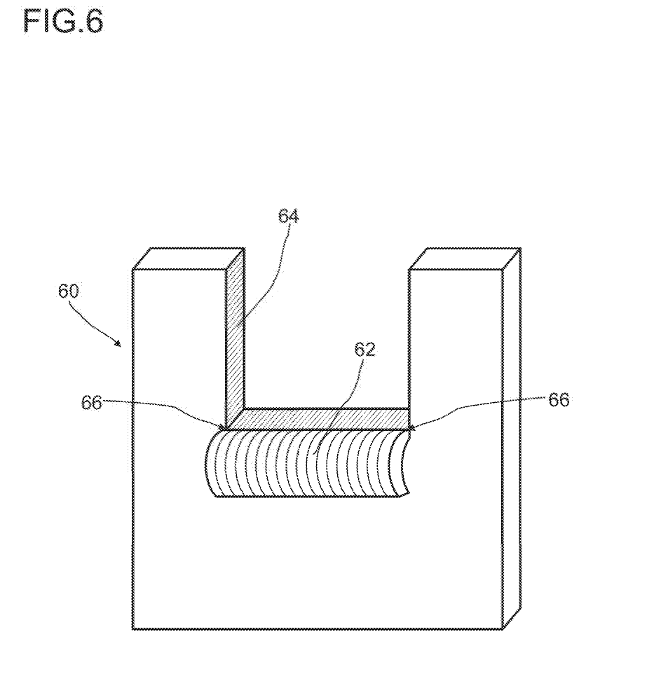

FIG. 6 is a diagram of failure mechanisms of a component reinforced with continuous-filament fibers,

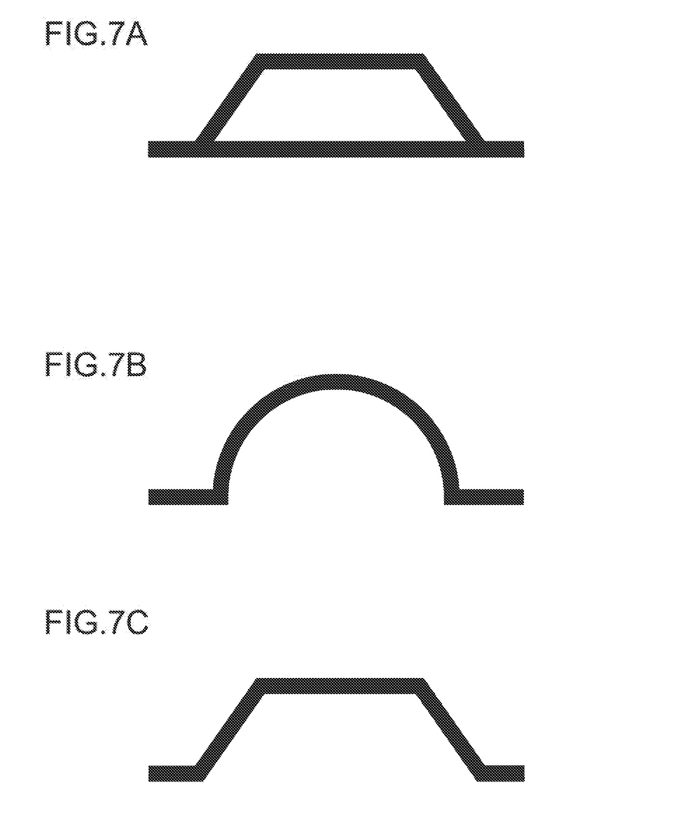

FIGS. 7a, 7b, and 7c show various profile shapes of a core structure, and

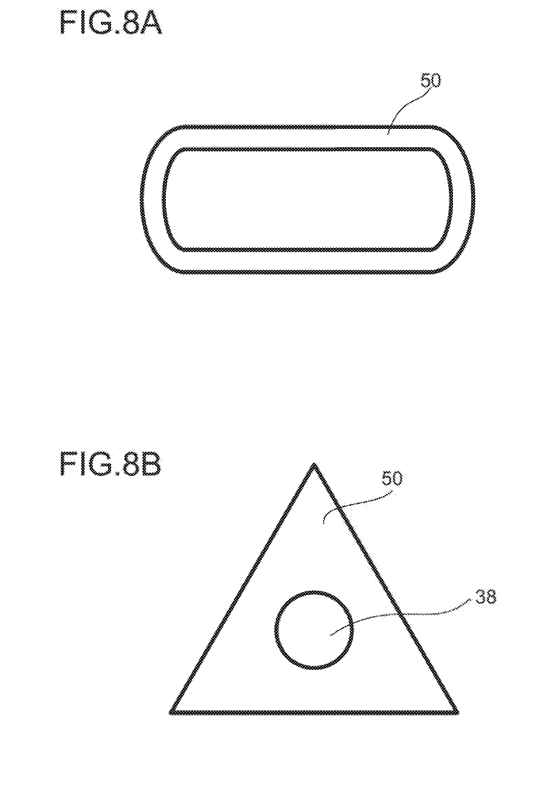

FIGS. 8a and 8b show various embodiments of an insert.

FIG. 1 is a perspective view of an energy-absorbing component 1 of the invention with a core structure 10 and an ancillary structure 12. There is a coherent bond between the core structure 10 and the ancillary structure 12. The shape of the core structure 10 in the embodiment depicted is approximately that of a tube where at each of two opposite ends of the tube the arrangement has, on the curved outer surface of the tube, a rib which seamlessly adjoins a first rib 16 of the ancillary structure 12. The arrangement has the first rib 16 in a first plane running in axial direction. The axial direction is indicated by the reference sign 2 in FIG. 1.

The ancillary structure 12 additionally comprises a large number of second ribs 14 arranged parallel to a second plane likewise running in axial direction. The second plane is rotated in relation to the first plane in such a way that an angle of 90° is included between the first plane and the second plane. The second ribs 14 intersect the first rib 16. A large number of third ribs 15 are moreover provided, each arranged parallel to a third plane running perpendicularly in relation to the axial direction.

Together with the second ribs 14 and the third ribs 15, the first rib 16 forms regions with the shape of rectangular parallelepipeds, where one side of the rectangular parallelepiped is open. The ancillary structure 12 with the ribs 14, 15, 16 supports the core structure 10 here in such a way that when this is exposed to a force which does not act exclusively in axial direction but also includes transverse components it does not buckle or undergo lateral fracture.

In the embodiment depicted in FIG. 1, some of the regions with the shape of rectangular parallelepipeds have further division via diagonal ribs 18, where each region having the shape of a rectangular parallelepiped is divided via a diagonal rib 18 into two regions of triangular shape. The triangular shape exhibits particularly high stiffness, and further reinforces the ancillary structure 12.

The regions situated between the ribs 14, 15, 16, and 18 are preferably filled with a foam (not depicted in FIG. 1). The structures 10, 12 are further supported by the foam. In the event of an impact, moreover, uncontrolled escape of sharp fragments from the structures 10, 12 is prevented or at least inhibited.

The ancillary structure 12 of the energy-absorbing component 1 is preferably produced in an injection-molding process. To this end, the arrangement of the ribs 14, 15, 16 and 18 is such that there are no resultant undercuts in relation to a plane of symmetry 20. The shape of the ancillary structure 12 depicted in FIG. 1 can therefore easily be produced by injection molding. The core structure 10 is not produced by means of injection molding, but as described below with reference to FIGS. 2a, and 2b is already a finished core structure 10 or a semifinished product when it is placed in a mold.

FIGS. 2a and 2b depict diagrammatically the production of the energy-absorbing component 1. Each of FIGS. 2a and 2b shows a mold 22 which comprises two mold profiles 23. The mold profiles 23 comprise protruding regions 24 and depressed regions 25 which provide a negative mold for an ancillary structure. The mold profiles 23 can be moved toward one another in order to close the mold 22.

In the embodiment depicted in FIG. 2a, a core structure 10 is placed in the mold 22 before closure of the mold 22. In the example depicted, the core structure 10 is composed of a first polymer material, reinforced with continuous-filament fibers. After closure of the mold 22, a second polymer material is injected into the mold 22 in order to produce the ancillary structure. The polymers of the first polymer material and of the second polymer material are selected here to be either identical or compatible with one another, so that a coherent bond forms between the resultant ancillary structure and the core structure 10. After manufacture of the ancillary structure, the mold 22 is again opened, and the resultant energy-absorbing component is removed. It is alternatively possible to manufacture the core structure 10 from a metal and to inject an ancillary structure 10 around same. In that case, a metallic core structure is placed in an appropriate mold and the second material is injected around same, thus producing an ancillary structure around the metallic core structure.

In the production process variant depicted in FIG. 2b, a semifinished product 11, instead of a core structure 10, is placed in the mold 22. In this example, the semifinished product has in turn been manufactured from a polymer material reinforced with continuous-filament fibers. If a thermoplastic is selected as polymer of the first polymer material, the semifinished product 11 is heated before placing in the mold 22. If a thermoset plastic is used, the plastic has not yet been hardened. On closure of the mold 22, this exerts pressure on the semifinished product 11 in such a way that this undergoes a forming process to give the core structure 10. After closure of the mold 22, the second polymer material is again injected in order to form the ancillary structure.

FIG. 3 depicts another variant of the energy-absorbing component 1. As described above in relation to FIG. 1, the energy-absorbing component 1 comprises a core structure 10 and an ancillary structure 12 coherently bonded thereto. The ancillary structure 12 depicted in FIG. 3 additionally comprises connection regions 30 which can be used to secure the energy-absorbing component 1 at its usage location or to connect it to other components. To this end, the energy-absorbing component comprises, at its rear side when viewed in axial direction, a fastening plate 32 with apertures 36. There are two screw domes 34 arranged at the upper side of the energy-absorbing component 1. The screw domes 34 can by way of example be used to secure other components.

Both the fastening plate 32 and the screw dome 34 are designed here as part of the ancillary structure 12, and are preferably manufactured together with the ancillary structure by means of injection molding.

FIG. 4 depicts an energy-absorbing component 1 which comprises a housing 40. The housing 40 comprises a core structure 10 with an ancillary structure 12 coherently bonded thereto as described in relation to FIG. 1. In the interior of the housing 40, between the housing 40 and the structures 10, 12 comprised therein, there remains a cavity 42 which preferably comprises a foam (not depicted in FIG. 4). The structures 10, 12 are embedded in the foam and connected by way of the foam to the housing 40.

In different embodiments the cavity 42 is completely filled with the foam or the foam is arranged only at selected sites in the cavity 42.

FIG. 5 shows the arrangement of an insert 50 at a core structure 10 of the energy-absorbing component 1. In the example depicted, the insert 50 takes the form of a rectangular frame, and is in contact at four contact sites 52 with the core structure 10 reinforced with continuous-filament fibers. Viewed in an axial direction, the insert 50 is in front of the core structure 10, and therefore in the event of a collision the insert 50 is forced into the core structure 10 or through the core structure 10. At the contact sites 52 the insert 50 cuts into the core structure 10 in the manner of a knife and thus prescribes starting points for cracks in the core structure 10. This reliably provides a defined destruction behavior or failure behavior of the core structure 10.

The insert 50 can by way of example be connected via connecting elements such as latching elements or spring-loaded elements arranged on the ancillary structure 12. Examples of other possible connection methods are use of screw threads or rivets to fix the insert 50, and also use of jointing processes such as adhesive bonding or welding. Alternatively, or in addition, the insert 50 can have been embedded together with the core structure 10 and the ancillary structure 12 in a foam.

FIG. 6 is a diagrammatic depiction of failure mechanisms of a component reinforced with continuous-filament fibers with reference to a panel 60 reinforced with continuous-filament fibers. The continuous-filament fibers 64 take the form of, by way of example, a woven fabric, a multiple-layer laid scrim, or a tape. In the example depicted, the arrangement has multiple layers 62 of the continuous-filament fibers 64. Action of a force from above breaks the continuous-filament fibers 64 at two cracks 66. Breakage of the continuous-filament fibers 64 requires a large amount of energy, and this therefore allows the panel 60 to absorb a large amount of energy. In addition, delamination occurs between the individual fiber layers 62 and in the example depicted in FIG. 6 some fiber layers tilt forward and some tilt backward. The delamination also requires energy, and energy is also therefore absorbed by way of this second failure mechanism.

A requirement of ideal absorption of the impact energy in both cases is that a crack 66 runs downward through the panel 60. Lateral break-away of the panel 60 would remove the panel 60 from the force acting on same without absorption of the energy as intended through cracking and delamination. The ancillary structure 12 therefore acts advantageously to support the core structure 10 reinforced with continuous-filament fibers, and ensures that, even on exposure to force with transverse components, the energy-absorbing component of the invention absorbs the energy to which it is exposed.

FIGS. 7a, 7b, and 7c show by way of example three different shapes of the core structure 10. Each of the shapes is depicted as cross section viewed in axial direction.

FIG. 7a shows a hollow profile with four angulations. This core structure can by way of example be obtained from two organopanels which are joined together. This achieved by subjecting a first organopanel to a drape-forming process and then joining same to a second organopanel by coherent bonding, for example by means of welding or adhesive bonding.

FIG. 7b shows a Ω-shaped core structure. This shape has two angulations and a circular arc between these, and can be obtained by way of example by subjecting an organopanel to a drape-forming process. If two of these Ω-shaped core structures are placed so that they represent mirror reflections of one another and are then joined, for example by welding or adhesive bonding, a tube with two ribs on the curved outer surface is obtained, as depicted in FIGS. 1, 3, 4, and 5.

FIG. 7c shows a core structure with four angulations, corresponding to the shape in FIG. 7a but not dosed by bonding to a second organopanel.

Other shapes of the core structure are also conceivable in addition to the examples depicted in FIGS. 7a, 7b, and 7c. If the core structure has been manufactured from a metal, this can in particular take the form of a metal profile or tube shortened to the required length.

FIGS. 8a and 8b depict two examples of inserts 50.

The insert 50 shown in FIG. 8a takes the form of flattened metal ring.

FIG. 8b shows an insert 50 of triangular shape. The insert 50 in FIG. 8b additionally comprises a connection element in the form of a screw thread 38, and the insert 50 therefore provides additional possibilities for securing other components.

### KEY

1 Energy-absorbing component
2 Axial direction
10 Core structure
11 Semifinished product
12 Ancillary structure
14 Second rib
15 Third rib
16 First rib
18 Diagonal rib
20 Plane of symmetry
22 Mold
23 Mold profile
24 Protruding region
25 Depressed region
30 Connection region
32 Fastening plate
34 Screw dome
36 Aperture
38 Screw thread
40 Housing
42 Cavity
50 Insert
52 Contact site
60 Panel
62 Fiber layer
64 Fiber
66 Crack

1-15. (canceled)

16. An energy-absorbing component for absorbing the energy of impacts thereon, where the energy-absorbing component can be plastically deformed by an impact and optionally can undergo at least some extent of destruction, wherein:
the energy-absorbing component comprises at least one core structure and at least one ancillary structure, where the at least one core structure has been manufactured from a first material which is a metal or is a polymer reinforced with continuous-filament fibers, and the at least one ancillary structure has been manufactured from a second material which is an unreinforced polymer material or is a polymer material reinforced with short fibers or with long fibers;
the at least one ancillary structure comprises ribs and the at least one ancillary structure has been bonded to at least one core structure; and
the energy-absorbing component is configured to absorb energy by defined and controlled destruction of the energy-absorbing component, such that most of the energy is absorbed via the at least one core structure, and the at least one core structure absorbs energy by way of various destruction mechanisms.

17. The energy-absorbing component according to claim 16, wherein the shape of the core structure is that of a tube or of a hollow cone frustum, or the core structure viewed in a planar section perpendicular to the axial direction comprises at least one angulation.

18. The energy-absorbing component according to claim 16, wherein the core structure viewed in a planar section perpendicular to the axial direction is undulatory, zig-zag-shaped, or Ω-shaped, or is composed of linear and/or curved sections.

19. The energy-absorbing component according to claim 16, wherein a wall thickness of the at least one core structure increases or decreases in an axial direction.

20. The energy-absorbing component according to claim 16, wherein the ancillary structure comprises at least one first rib which runs in a first plane in axial direction and has connection to at least one second rib running in a second plane in axial direction, rotated in relation to the first plane.

21. The energy-absorbing component according to claim 20, wherein the ancillary structure additionally comprises at least one third rib, arranged perpendicularly in relation to the axial direction.

22. The energy-absorbing component according to claim 16, wherein the continuous-filament fibers and/or optionally the short fibers or long, fibers are selected from glass fibers, carbon fibers, aramid fibers, basalt fibers, boron fibers, metal fibers, and potassium titanate fibers.

23. The energy-absorbing component according to claim 16, wherein the energy-absorbing component additionally comprises at least one insert, where the insert is arranged in contact with a core structure on the side at which the impact acts on the component, and at least to some extent covers the core structure, and/or the insert comprises a connection element for connection to other components, where the insert is preferably in contact with the core structure at from 1 to 10 contact sites.

24. The energy-absorbing component according to claim 16, wherein a defined failure behavior on impact has been established via selection of the number of core structures, selection of the first material, selection of the wall thickness of the at least one core structure, and/or selection of the number of contact sites of an insert arranged on the core structure.

25. The energy-absorbing component according to claim 16, wherein the at least one ancillary structure comprises at least one connection region.

26. The energy-absorbing component according to claim 16, which comprises a housing which comprises the, at least one core structure and the at least one ancillary structure.

27. A process for producing an energy-absorbing component according claim 1 with at least one core structure and at least one ancillary structure, comprising:
a) placing at least one core structure produced from a first material, or at least one semifinished sheet produced from a first material for producing a core structure into a mold comprising at least two mold profiles movable in opposite direction, where protruding regions and depressed regions of the mold profiles comprise a negative image of an ancillary structure, and where the first material is selected from a metal or from a polymer material reinforced with continuous-filament fibers;
b) closing the mold, where on closure of the mold any semifinished product inserted is subjected to a forming process to give a core structure;
c) injecting a second material into the mold, where the at least one ancillary structure is formed, and where the second material is a non-fiber-reinforced polymer or is a polymer reinforced with short fibers or with long fibers; and
d) opening the mold and removing the component.

28. The process according to claim 27, wherein in step a) at least one insert is additionally placed in the mold.

29. The process according to claim 27, wherein after removal of the component from the mold cavities of the energy-absorbing component are filled with a foam.

30. The process according to claim 27, wherein a force-displacement characteristic of the energy-absorbing component is established via selection of the at least one core structure.
